(19) United States
(12) Patent Application Publication
(10) Pub. No.: US 2026/0351224 A1
(43) Pub. Date: Nov. 5, 2026

(54) MUSICAL INSTRUMENT STAND

(71) Applicant: K.H.S. MUSICAL INSTRUMENT CO., LTD., New Taipei City (TW)

(72) Inventor: CHAN-HSU LIN, New Taipei City (TW)

(73) Assignee: K.H.S. MUSICAL INSTRUMENT CO., LTD., New Taipei City (TW)

(21) Appl. No.: 19/194,754

(22) Filed: Apr. 30, 2025

(51) Int. Cl. G10D 13/10; F16M 11/04; F16M 11/06; F16M 11/24

(52) U.S. Cl. CPC G10D 13/28; F16M 11/041; F16M 11/06; F16M 11/245

(57) ABSTRACT

The invention provides a musical instrument stand, comprising: a connecting frame, a bracket arm group and a positioning mechanism. The bracket arm group is connected to the connecting frame to form a clamping area to clamp a musical instrument, and a movable bracket arm of the bracket arm group is capable of being moved along a moving axis to expand or shrink the clamping area. The positioning mechanism is disposed on the connecting frame, and an actuating body of the positioning mechanism is moved along a brake axis, so that a movable member of the positioning mechanism is separated from the movable bracket arm, thereby making the movable bracket arm unable to move. Therefore, the movable bracket arm cooperates with the positioning mechanism to flexibly adjust the size of the clamping area, so that musical instruments of various contour sizes is clamped by the bracket arm group, thereby increasing the practicality of the musical instrument stand.

### FIELD OF THE INVENTION

The invention relates to a musical instrument stand capable of being clamped to a musical instrument, and in particular to a musical instrument stand capable of changing the size of a clamping area R according to a contour of the musical instrument stand, so that the musical instrument stand is clamped to the musical instruments of various contour sizes.

### BACKGROUND OF THE INVENTION

A jazz drum is a comprehensive musical instrument composed of a variety of drums and percussion instruments with different timbres. The common composition of the jazz drum includes: a bass drum, a snare drum, a tom-tom, a floor drum, alto cymbals, hi-hat cymbals and a bass drum pedal. Among them, the snare drum plays a vital role in the musical performance of the jazz drum due to its special timbre and playing techniques. In order to ensure the stability of the snare drum during the musical performance, most snare drums are used in cooperation with a drum stand, and the drum stand is mainly fixed to the snare drum in a clamping manner, so that the snare drum is positioned at a preset position, and the drum stand is prevented the snare drum from being displaced when being struck.

However, currently conventional drum stands commonly found on the market generally have a dimension limitation problem, so that conventional drum stands usually only is clamped snare drums of a specific dimension, resulting in conventional drum stands being unable to be suitable for snare drums of various dimensions. Therefore, when a drummer needs to replace a snare drum of a different dimension, the original conventional drum stand may not be able to clamp another snare drum, and the drummer must purchase another drum stand that meets the dimension of the other snare drum, not only makes the conventional drum stands be inconvenient to use, but also increases additional cost expenditure.

### SUMMARY OF THE INVENTION

A main objective of the invention is to improve the structural pattern of a musical instrument stand, and the improved musical instrument stand is capable of being clamped musical instruments of various contour sizes, thereby increasing the practicality of the musical instrument stand.

A secondary objective of the invention is to improve the structural pattern of the positioning mechanism, so that a user conveniently is operated the improved positioning mechanism to adjust the contour size of a clamping area of a bracket arm group.

To achieve the aforementioned objectives, the invention provides a musical instrument stand, is used in cooperation with a musical instrument and includes: a connecting frame, a bracket arm group, and a positioning mechanism.

The bracket arm group has a plurality of bracket arms connected to the connecting frame. A clamping area is formed between the bracket arms for clamping the musical instrument, and one of the bracket arms is configured as a movable bracket arm movably connected to the connecting frame. The movable bracket arm is capable of being moved along a moving axis to expand or shrink the clamping area.

The positioning mechanism is disposed on the connecting frame, and has a movable member and a returning member. The movable member is movably connected to the connecting frame, so that the movable member is capable of being moved along a brake axis intersecting the moving axis, and the movable member is capable of being moved back and forth between a separation position separated from the movable bracket arm and a contact position in contact with the movable bracket arm. The movable member is moved by the returning member to kept in the contact position, so that the movable bracket arm is stopped to move relative to the connecting frame.

The movable member has an actuating body and a brake pad. When the movable member is moved to the separation position by operating the actuating body,, the brake pad is separated from the movable bracket arm. When the movable member is located at the contact position, the brake pad is contact with the movable bracket arm.

In an embodiment, the movable member further has a linking body, is used for allowing the actuating body and the brake pad to move in the same direction of the brake axis, and two ends of the linking body are respectively connected to the actuating body and the brake pad, so that an accommodating channel is formed among the actuating body, the brake pad and the linking body, where the actuating body is located on one side of the movable bracket arm, and the brake pad is located on the other side of the movable bracket arm, so that the movable bracket arm is capable of passing through the accommodating channel, and a part of the movable bracket arm is allowed to be located inside the accommodating channel, while two ends of the returning member respectively abut against the linking body and the connecting frame.

In another embodiment, the actuating body and the brake pad are both located on the same side of the movable bracket arm, and the returning member is located inside the accommodating channel and respectively abuts against the linking body and the connecting frame at both ends.

In a further embodiment, the movable member further has a linking body, is used for allowing the actuating body and the brake pad to move in opposite directions of the brake axis, so that the actuating body is capable of being moved along a first direction of the brake axis, while the brake pad is moved along a second direction of the brake axis, and the first direction is opposite to the second direction. The linking body has a linkage gear pivoted to the connecting frame, an actuating rack connected to the actuating body and an abutting rack connected to the brake pad. The actuating rack and the abutting rack are respectively meshed with opposite sides of the linkage gear, so that when the actuating body moves along the first direction of the brake axis, the actuating rack is drove the linkage gear to rotate, and the abutting rack is moved along the second direction of the brake axis through the rotating linkage gear.

In yet a further embodiment, the linking body includes: a linkage rod, an actuating protrusion, and an abutting protrusion. The linkage rod is pivoted to the connecting frame, and is formed with an actuating slot hole and an abutting slot hole at two ends thereof respectively. The actuating protrusion is formed on the actuating body and is inserted into the inside of the actuating slot hole. Additionally, the abutting protrusion is formed on the brake pad and is inserted into the inside of the abutting slot hole.

The actuating protrusion is moved by the actuating body along the first direction of the brake axis, so that the actuating protrusion moves inside the actuating slot hole to allow the linkage rod to swing, when the relative position between the abutting protrusion and the abutting slot hole is changed, and the brake pad is moved by the abutting protrusion along the second direction of the brake axis.

In the last embodiment, the positioning mechanism further has a linking body for converting linear motion into rotational motion. The linking body is connected between the actuating body and the brake pad, when the actuating body moves along the brake axis, the brake pad is swung by the linking body to get closer to or for away from the movable bracket arm. In this embodiment, the linking body includes: a moving rod, a rotating disk and a swinging rod. The moving rod is connected to the actuating body and has a longitudinal slot. The rotating disk is pivoted to the connecting frame and has a disk protrusion that is inserted into the longitudinal slot, and additionally the swinging rod is connected between the brake pad and the rotating disk. The movement of the actuating body along the brake axis changes the relative position between the disk protrusion and the longitudinal slot, so that the rotating disk rotates, and the brake pad is swing to the swinging rod can drive to get closer to or far away from the movable bracket arm.

In the aforementioned embodiments, a connecting space is provided inside the connecting frame to accommodate the positioning mechanism, the actuating body and the brake pad, and the connecting frame has bracket through-holes communicated with the connecting space. The movable bracket arm passes through the connecting space, so that the movable bracket arm is formed with a built-in section located in the connecting space and two exposed sections protruding from the bracket through-holes. The built-in section is located between the two exposed sections, and each of the exposed sections are protruded outside the connecting space to form an anti-detachment block, and the two anti-detachment blocks are contacting the connecting frame for preventing the movable bracket arm from separating the connecting frame.

Further, the connecting frame is provided with positioning surfaces spaced at intervals from each other in the connecting space, and a linking body connected between the actuating body and the brake pad is located between the positioning surfaces spaced. When the actuating body moves along the brake axis, the linking body is contacted one of the positioning surfaces to limit a moving distance of the actuating body in the connecting space, where a positioning space is further provided in the connecting frame and locates below the connecting space, and the positioning surfaces are formed on two opposite sides of the positioning space, so that a part of the linking body is arranged inside the positioning space.

Moreover, the connecting frame has a first connecting portion capable of being connected to the bracket arm group and a second connecting portion formed on one side of the first connecting portion. The transverse cross-sectional profile of the first connecting portion is larger than that of the second connecting portion, so that an exposed space is formed between the first connecting portion and the second connecting portion, and the second connecting portion is connected to a support via an angle adjuster, and the angle adjuster is located inside the exposed space for changing an assembling angle of the connecting frame.

In a preferred embodiment, the connecting frame has a connecting body and a covering body. The connecting body is provided with a base, a connecting arm formed in the base and a pivot rod connected to the connecting arm. The covering body is connected to the base, so that the covering body and the base together form the first connecting portion, and the pivot rod is pivoted to the angle adjuster, so that the connecting arm is adjacent to the angle adjuster, and the connecting arm and the pivot rod together form the second connecting portion.

The invention is characterized in that the movable member of the positioning mechanism moves along the brake axis, so that the movable member moves to the separation position, the movable member is allowed to be separated from the movable bracket arm of the bracket arm group, and thus the movable bracket arm is capable of being moved along the moving axis to expand or shrink the clamping area. Additionally, the returning member of the positioning mechanism is capable of being driven the movable member to move to the contact position, so that the movable member contacts the movable bracket arm to generate a frictional force, thereby preventing the movable bracket arm from moving relative to the connecting frame to fix the size of the clamping area. Thereby, the movable bracket arm cooperates with the positioning mechanism to flexibly and steplessly adjust the size of the clamping area, so that musical instruments of various contour sizes is clamped by the bracket arm group, thereby increasing the practicality of the musical instrument stand.

Moreover, the movable member of the positioning mechanism is capable of being moved along the brake axis, so that the user is capable of being pressed or pulled the movable member to move it from the contact position to the separation position, and thus the movable bracket arm is capable of being moved along the moving axis to expand or shrink the clamping area. Additionally, when the user releases the movable member, the movable member is moved by the returning member of the positioning mechanism to kept in the contact position, so that the movable member contacts the movable bracket arm to generate a frictional force, thereby preventing the movable bracket arm from moving relative to the connecting frame to fix the size of the clamping area. Thereby, the positioning mechanism is conveniently operated by the user to adjust the contour size of the clamping area of the bracket arm group.

### BRIEF DESCRIPTION OF THE DRAWINGS

FIG. 1 is a perspective view of a musical instrument stand in a first preferred embodiment of the invention;

FIG. 2 is an exploded view of the musical instrument stand in the first preferred embodiment of the invention;

FIG. 3A is a schematic diagram of a supporting foot rest in a supporting state;

FIG. 3B is a schematic diagram of the supporting foot rest in a received state;

FIG. 4 is a schematic diagram of a bracket arm group and a positioning mechanism in FIG. 1 installed on a connecting frame;

FIG. 5 is a cross-sectional view of the bracket arm group and the positioning mechanism in FIG. 1 installed on the connecting frame;

FIG. 6A is a schematic diagram of the bracket arm group in a close-together state;

FIG. 6B is a schematic diagram of the bracket arm group in an expanding state;

FIG. 7A is a schematic diagram of a movable member in a contact position;

FIG. 7B is a schematic diagram of the movable member in a separated position;

FIG. 7C is a schematic diagram of the movable bracket arm moving to increase a clamping area;

FIG. 7D is a schematic diagram of the movable bracket arm moving to reduce the clamping area;

FIG. 8 is a schematic diagram of a musical instrument stand in a second preferred embodiment of the invention;

FIG. 9 is a schematic diagram of adjusting the contour size of the clamping area in the second preferred embodiment of the invention;

FIG. 10 is a schematic diagram of a musical instrument stand in a third preferred embodiment of the invention;

FIG. 11 is a schematic diagram of adjusting the contour size of the clamping area in the third preferred embodiment of the invention;

FIG. 12 is a schematic diagram of a musical instrument stand in a fourth preferred embodiment of the invention;

FIG. 13 is a schematic diagram of adjusting the contour size of the clamping area in the fourth preferred embodiment of the invention;

FIG. 14 is a schematic diagram of a musical instrument stand in a fifth preferred embodiment of the invention; and

FIG. 15 is a schematic diagram of adjusting the contour size of the clamping area in the fifth preferred embodiment of the invention.

### DETAILED DESCRIPTION OF THE PREFERRED EMBODIMENTS

In order to have further clear and detailed knowledge and understanding of the construction, use and features of the invention, preferred embodiments are given and described in detail with reference to the drawings as follows:

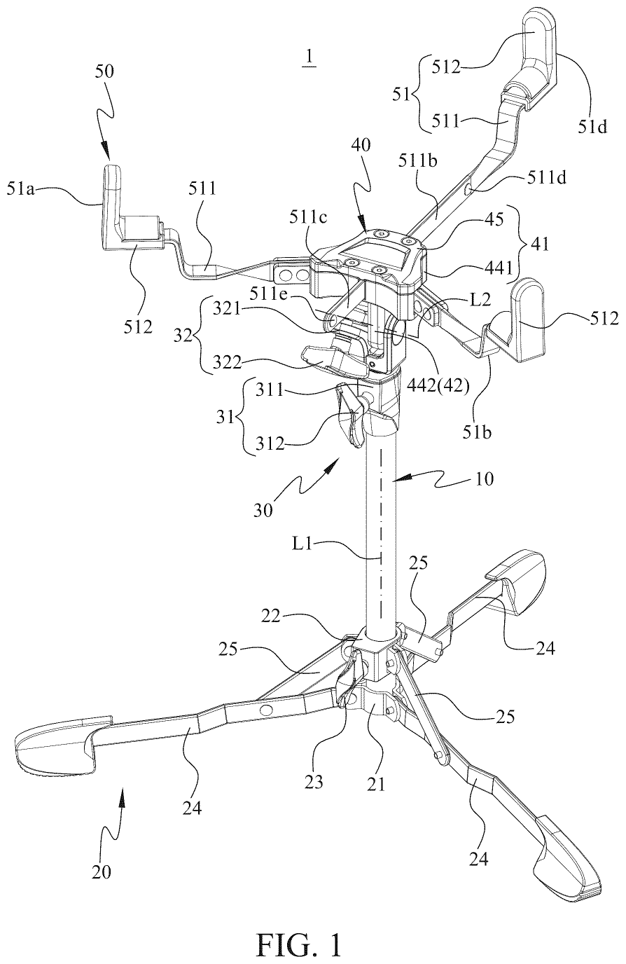

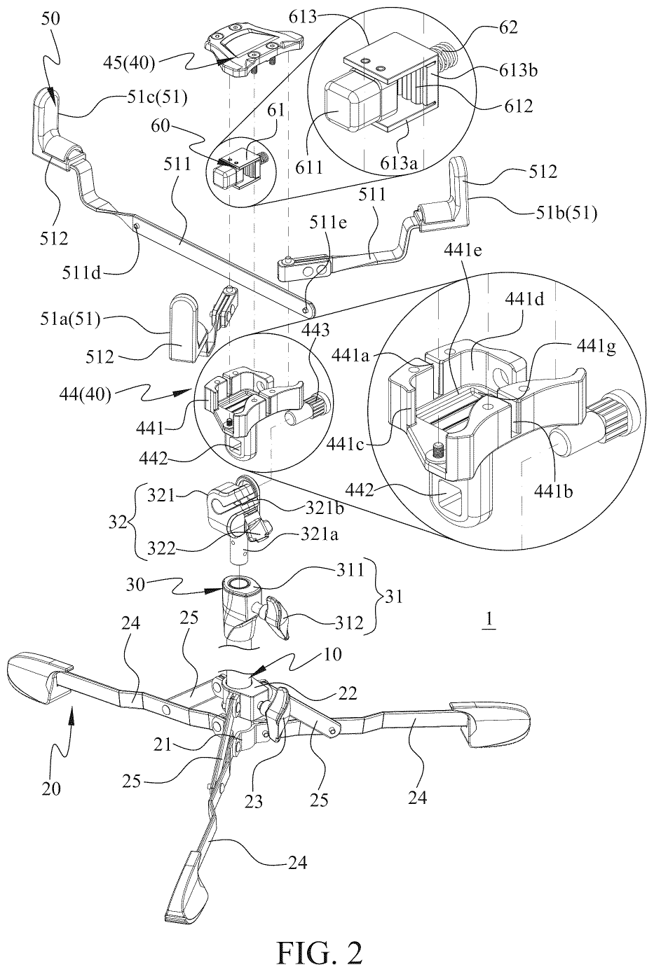

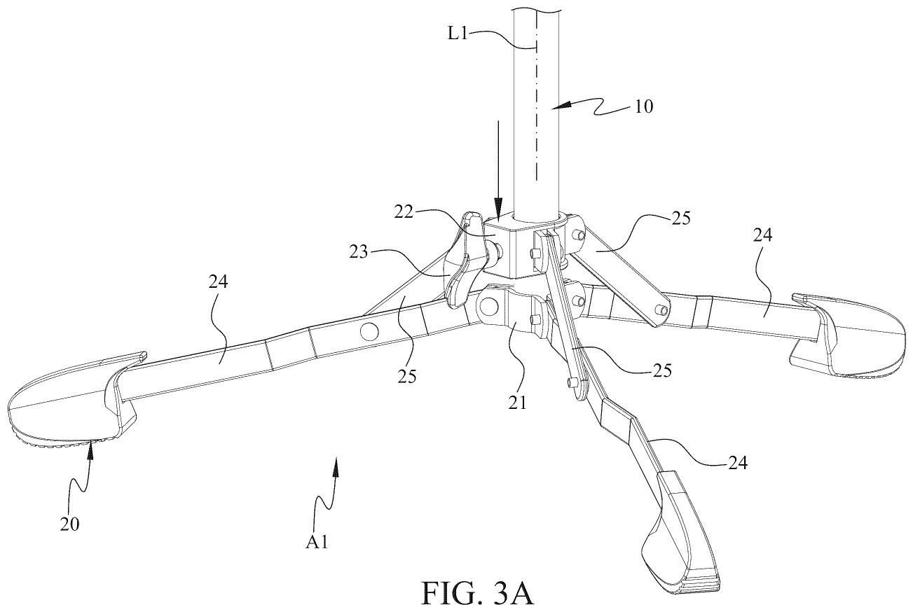

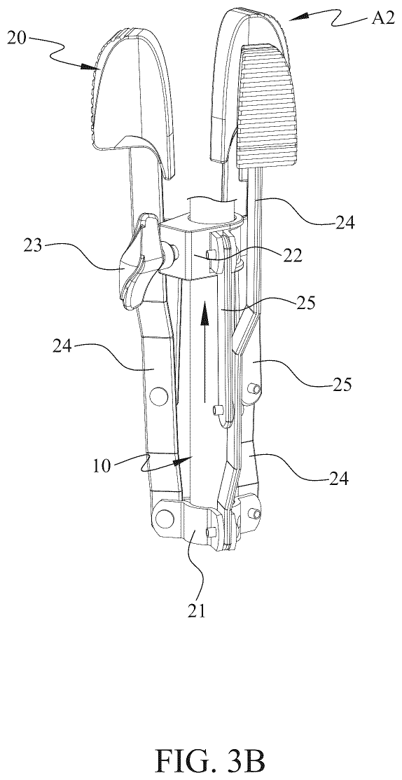

Referring to FIGS. 1 and 2, in a first preferred embodiment, a musical instrument stand 1 of the invention is used in cooperation with a musical instrument (e.g.: a snare drum), and the musical instrument stand 1 is mainly composed of a support 10, a supporting foot rest 20, an angle adjuster 30, a connecting frame 40, a bracket arm group 50 and a positioning mechanism 60. Two ends of the support 10 are respectively connected to the supporting foot rest 20 and the angle adjuster 30, and the supporting foot rest 20 has five portions, namely a fixed sleeve 21, a movable sleeve 22, a foot rest locking member 23, a plurality of foot rest legs 24 and a plurality of linking rods 25. The fixed sleeve 21 is fixed to an end of the support 10 so that the fixed sleeve 21 is stopped to move relative to the support 10, and the movable sleeve 22 is movably connected to the support 10 so that the movable sleeve 22 is moved up and down along the support 10 to selectively approach or move far away from the fixed sleeve 21, where the foot rest locking member 23 is spirally embedded into the movable sleeve 22, and the foot rest locking member 23 is increased the surface area of the movable sleeve 22 contacting the support 10 by rotating clockwise, thereby preventing the movable sleeve 22 from moving relative to the support 10. Conversely, the foot rest locking member 23 reduces the surface area of the movable sleeve 22 contacting the support 10 by rotating counterclockwise, so that the movable sleeve 22 is moved relative to the support 10. Furthermore, each foot rest leg 24 is pivoted to the fixed sleeve 21, where one end of each linking rod 25 is pivoted to the movable sleeve 22, and the other end of each linking rod 25 is pivoted one-to-one to one of the foot rest legs 24, so that a linking rod 25 is provided between each foot rest leg 24 and the fixed sleeve 21. In this embodiment, as shown in FIG. 3A, the movable sleeve 22 moves relative to the support 10 to approach the fixed sleeve 21, so that each foot rest leg 24 will be far away from the support 10 to be supported on the ground, and the supporting foot rest 20 is capable of being presented a supporting state A1. Additionally, as shown in FIG. 3B, the movable sleeve 22 moves relative to the support 10 to be far away from the fixed sleeve 21, so that each foot rest leg 24 swings toward the support 10, and each foot rest leg 24 is adjacent to the support 10, and the supporting foot rest 20 is transformed from the supporting state A1 to a received state A2.

As shown in FIG. 2, the angle adjuster 30 is connected between the support 10 and the connecting frame 40, and the angle adjuster 30 is used for changing a tilt angle of the connecting frame 40, where the angle adjuster 30 has two portions, namely a longitudinal angle adjustment group 31 and a transverse angle adjustment group 32. As shown in the figure, the longitudinal angle adjustment group 31 is provided with a longitudinal adjustment body 311 movably connected to the support 10 and a longitudinal locking member 312 spirally embedded into the longitudinal adjustment body 311. The longitudinal adjustment body 311 rotates relative to the support 10 with a longitudinal axis L1 parallel to the support 10 as an axle center, and the longitudinal locking member 312 increases the surface area of the longitudinal adjustment body 311 in contact with the support 10 by rotating clockwise, thereby preventing the longitudinal adjustment body 311 from rotating with the longitudinal axis L1 as the axle center. Conversely, the longitudinal locking member 312 is reduced the surface area of the longitudinal adjustment body 311 in contact with the support 10 by rotating counterclockwise, so that the longitudinal adjustment body 311 is rotated with the longitudinal axis L1 as the axle center. Additionally, the transverse angle adjustment group 32 is provided with a transverse adjustment body 321 and a transverse locking member 322. As shown in the figure, a part of the transverse adjustment body 321 is connected to the longitudinal adjustment body 311 to form a supporting portion 321a, and the remaining part of the transverse adjustment body 321 is pivoted to the connecting frame 40 to form a clamping portion 321b, so that the connecting frame 40 is rotated relative to the transverse adjustment body 321 with a transverse axis L2 perpendicular to the longitudinal axis L1 as the axle center, and the transverse locking member 322 is spirally embedded into the clamping portion 321b. The transverse locking member 322 is increased the surface area of the clamping portion 321b in contact with the connecting frame 40 by rotating clockwise, thereby preventing the connecting frame 40 from rotating with the transverse axis L2 as the axle center. Conversely, the transverse locking member 322 is reduced the surface area of the clamping portion 321b in contact with the connecting frame 40 by rotating counterclockwise, so that the connecting frame 40 is rotated with the transverse axis L2 as the axle center.

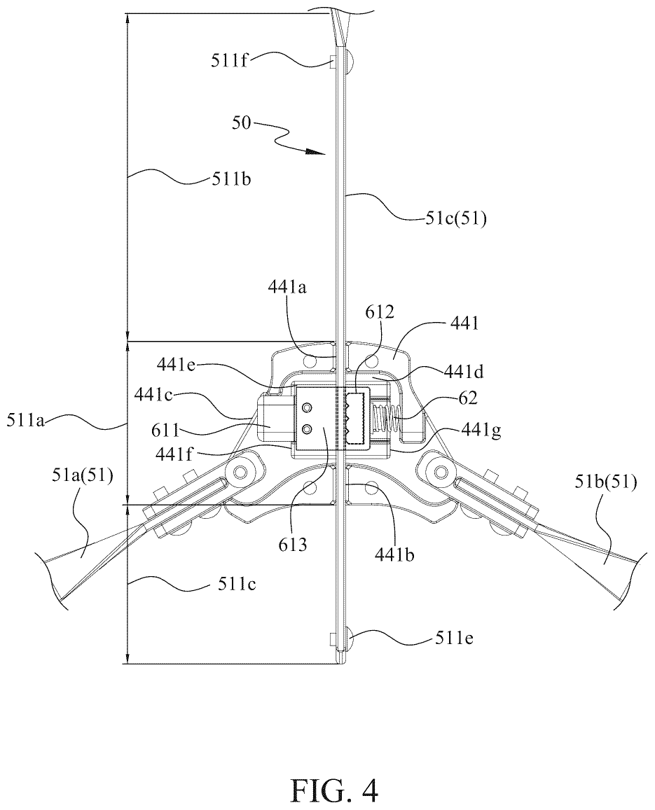

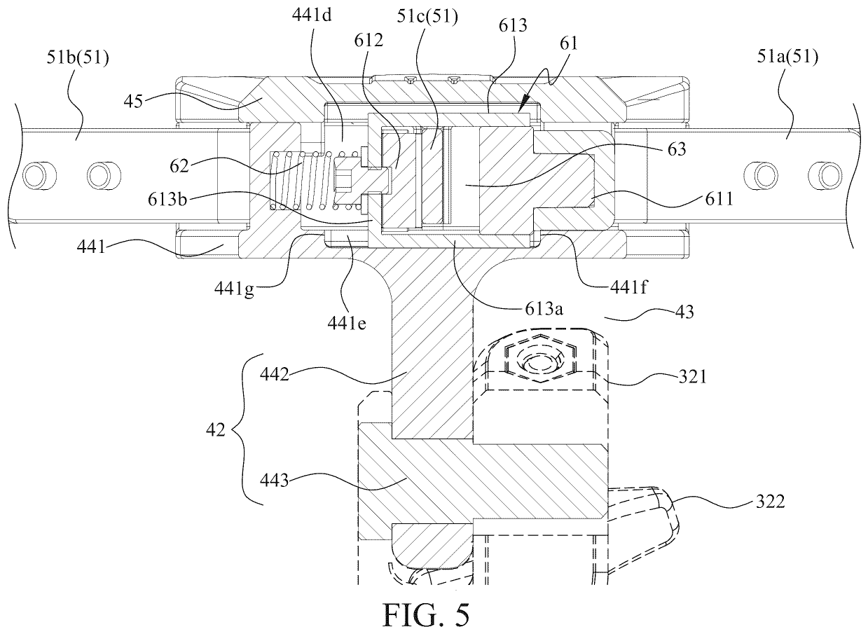

Referring to FIGS. 2, 4 and 5, a connecting frame 40 is provided with two portions, namely a first connecting portion 41 and a second connecting portion 42. The first connecting portion 41 is used for connecting to the bracket arm group 50 and the positioning mechanism 60, and the second connecting portion 42 is formed on the bottom side of the first connecting portion 41, and the second connecting portion 42 is used for pivotally connecting to the clamping portion 321b of the transverse adjustment body 321. The transverse cross-sectional profile of the first connecting portion 41 is larger than that of the second connecting portion 42, so that the connecting frame 40 forms an exposed space 43 surrounding the second connecting portion 42 below the first connecting portion 41, and thus the exposed space 43 is between the first connecting portion 41 and the second connecting portion 42, and the angle adjuster 30 is located inside the exposed space 43. As shown in the figure, the connecting frame 40 is mainly composed of a connecting body 44 and a covering body 45. The connecting body 44 is provided with a base 441, a connecting arm 442 and a pivot rod 443. The base 441 is connected to the covering body 45, a first bracket through hole 441a, a second bracket through hole 441b and a switch through hole 441c are formed around the base 441, and the first bracket through hole 441a, the second bracket through hole 441b and the switch through hole 441c are all communicated with a connecting space 441d concavely formed inside the base 441, and then the connecting space 441d is communicated with a positioning space 441e located below the connecting space 441d, so that the base 441 is concavely form the connecting space 441d and the positioning space 441e from top to bottom sequentially, and the two opposite sides of the positioning space 441e respectively form a first positioning surface 441f and a second positioning surface 441g. The first positioning surface 441f is close to the switch through hole 441c, and the second positioning surface 441g is far from the switch through hole 441c. Additionally, the connecting arm 442 is formed on the bottom side of the base 441, and the pivot rod 443 is inserted into the clamping portion 321b of the transverse adjustment body 321 through the connecting arm 442, so that the connecting arm 442 is adjacent to the angle adjuster 30. In this embodiment, the base 441 and the covering body 45 together form the first connecting portion 41, and the connecting arm 442 and the pivot rod 443 together form the second connecting portion 42.

Referring to FIGS. 2, 4 and 5, the bracket arm group 50 is connected to the connecting frame 40, the bracket arm group 50 is mainly composed of three bracket arms 51, and the three bracket arms 51 is jointly form a clamping area R for clamped the musical instrument, where each bracket arm 51 is provided with a bearing arm body 511 and a claw sleeve 512 connected to an end of the bearing arm body 511. In this embodiment, the bearing arm body 511 of one bracket arm 51 is pivoted to the base 441 of the first connecting portion 41 and is configured as a first swing bracket arm 51a, and the bearing arm body 511 of another bracket arm 51 is pivoted to another position of the base 441 and is configured as a second swing bracket arm 51b, so that both the first swing bracket arm 51a and the second swing bracket arm 51b are swung relative to the connecting frame 40, and the bearing arm body 511 of the last bracket arm 51 is inserted into the first bracket through hole 441a and the second bracket through hole 441b of the base 441 and is configured as a movable bracket arm 51c, and thus the movable bracket arm 51c is enabled to move relative to the connecting frame 40 along a moving axis L3, where when the movable bracket arm 51c is inserted into the first bracket through hole 441a and the second bracket through hole 441b, the bearing arm body 511 of the movable bracket arm 51c is passed through the connecting space 441d of the connecting frame 40, so that the bearing arm body 511 of the movable bracket arm 51c has a built-in section 511a located in the connecting space 441d, a first exposed section 511b exposed outside the connecting space 441d through the first bracket through hole 441a, and a second exposed section 511c exposed outside the connecting space 441d through the second bracket through hole 441b. As shown in the figure, the first exposed section 511b protrudes to form a first anti-detachment block 511d, and the first exposed section 511b is sleeved by the claw sleeve 512 of the movable bracket arm 51c at one end far away from the connecting frame 40, and the second exposed section 511c protrudes to form a second anti-detachment block 511e.

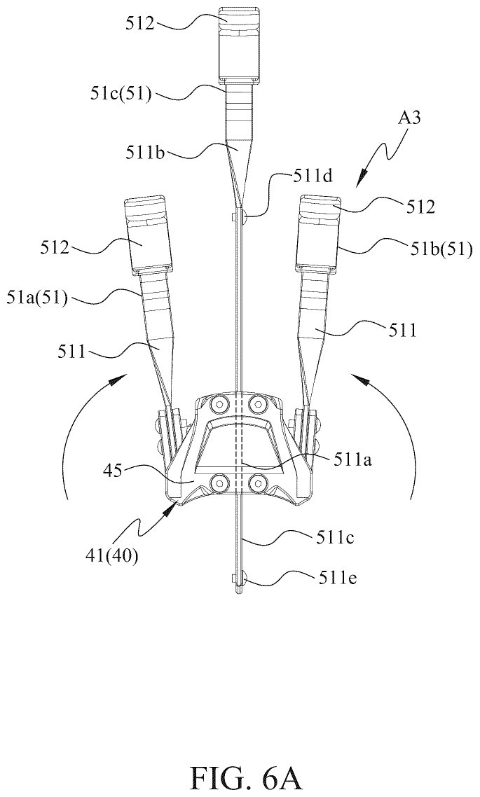

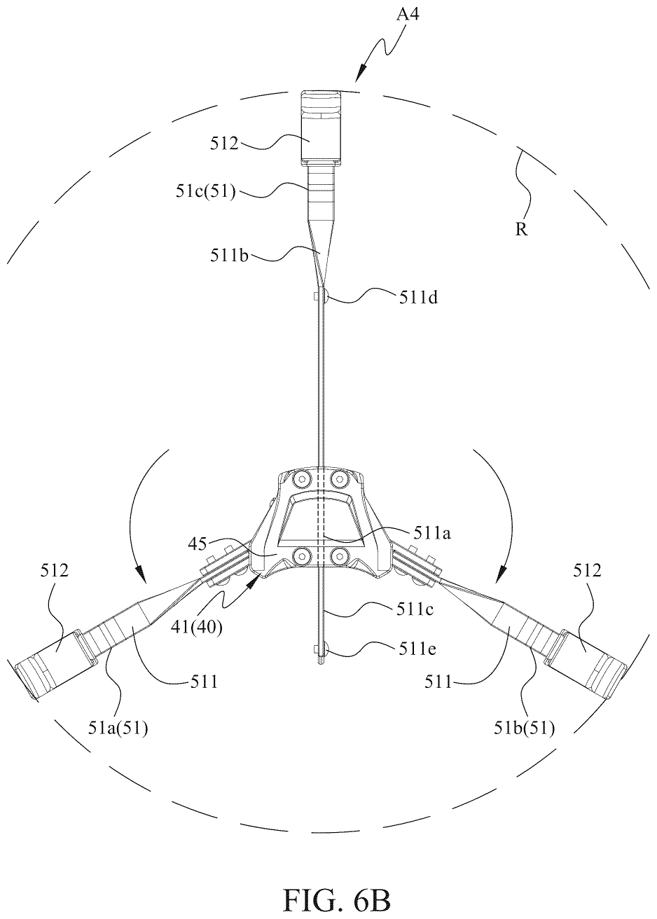

In this embodiment, as shown in FIG. 6A, the first swing bracket arm 51a and second swing bracket arm 51b of the bracket arm group 50 are swung relative to the connecting frame 40, so that the first swing bracket arm 51a and the second swing bracket arm 51b are closed to the first exposed section 511b of the movable bracket arm 51c, and the first swing bracket arm 51a and the second swing bracket arm 51b are respectively adjacent to the two opposite sides of the first exposed section 511b, so that the bracket arm group 50 presents a close-together state A3. Also as shown in FIG. 6B, the first swing bracket arm 51a and the second swing bracket arm 51b of the bracket arm group 50 swing relative to the connecting frame 40, so that the first swing bracket arm 51a and the second swing bracket arm 51b are far away from the first exposed section 511b of the movable bracket arm 51c, and the first swing bracket arm 51a and the second swing bracket arm 51b are spaced apart at two opposite sides of the second exposed section 511c of the movable bracket arm 51c. In this way, the bracket arm group 50 changes from the close-together state A3 to an expanding state A4, so that the first swing bracket arm 51a and the second swing bracket arm 51b and the movable bracket arm 51c together form a clamping area R.

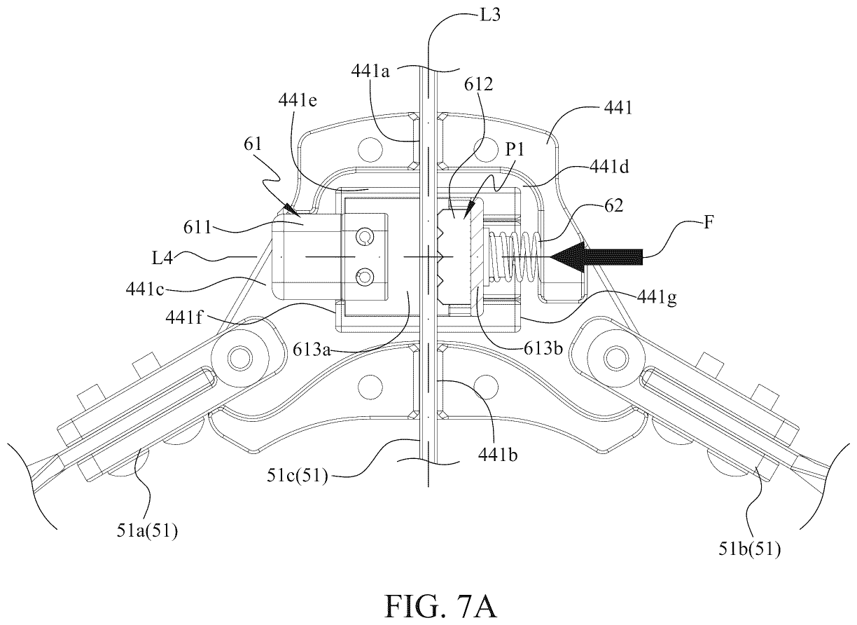

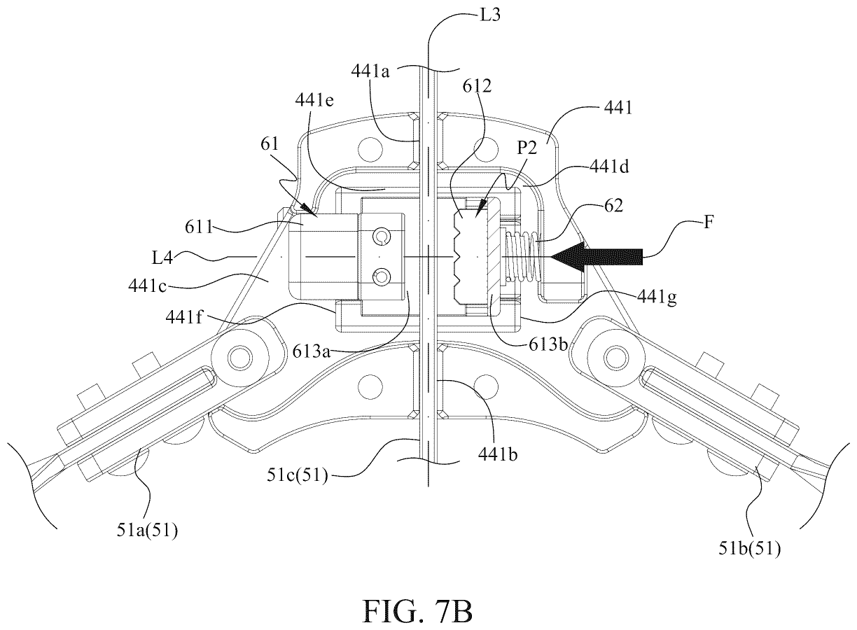

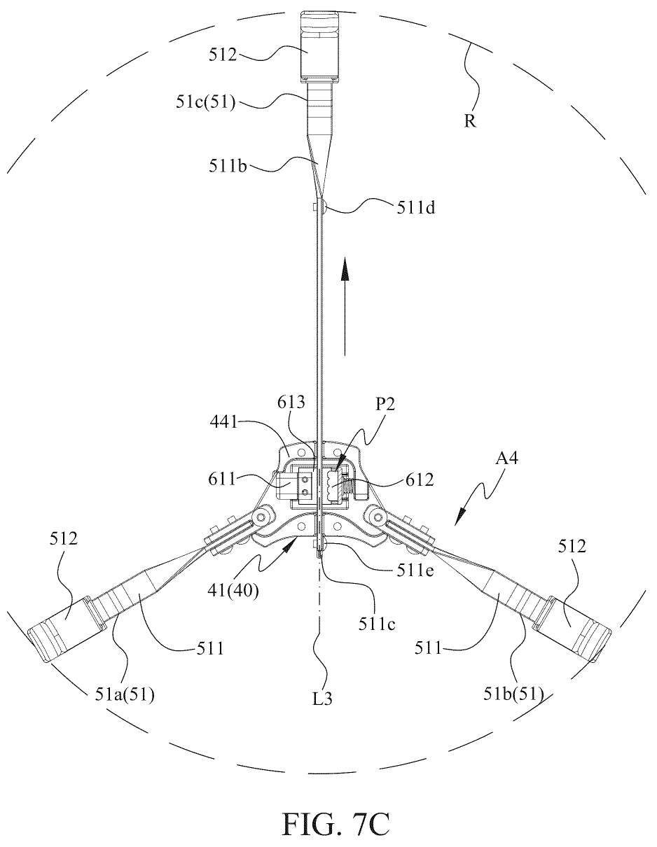

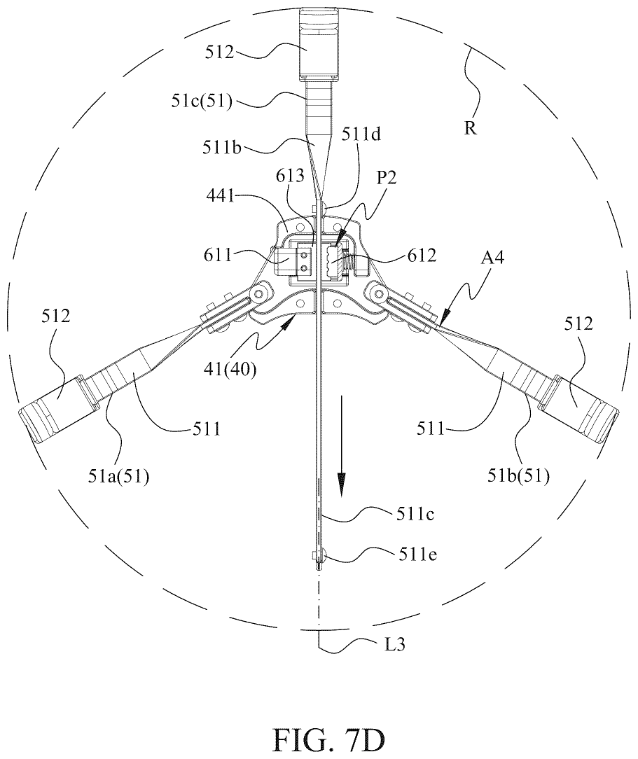

Referring to FIGS. 2, 4 and 5, the positioning mechanism 60 is disposed on the connecting frame 40, and the positioning mechanism 60 is provided with a movable member 61 and a returning member 62 in the connecting space 441d of the connecting frame 40. As shown in the figure, the movable member 61 is mainly composed of an actuating body 611, a brake pad 612 and a linking body 613. The actuating body 611 is movably connected to the base 441 of the connecting frame 40, and the actuating body 611 is located on one side of the built-in section 511a of the movable bracket arm 51c, and the actuating body 611 is capable of being moved relative to the connecting frame 40 along a brake axis L4 intersecting the moving axis L3, so that the actuating body 611 is moved by passing through the switch through hole 441c of the connecting frame 40. Additionally, the brake pad 612 is located at the other side of the built-in section 511a, so that the built-in section 511a is located between the actuating body 611 and the brake pad 612, and the linking body 613 is formed with a first linking portion 613a connected to the actuating body 611 and a second linking portion 613b connected to the brake pad 612. The first linking portion 613a is located inside the positioning space 441e of the connecting frame 40 so as to be able to span the built-in section 511a, and the second linking portion 613b is vertically arranged on the first linking portion 613a. An accommodating channel 63 for accommodating the built-in section 511a is formed among the actuating body 611, the brake pad 612 and the linking body 613. In this embodiment, the two ends of the linking body 613 are respectively connected to the actuating body 611 and the brake pad 612, so that the linking body 613 is used for allowing the actuating body 611 and the brake pad 612 to move in the same direction of the brake axis L4. Moreover, the returning member 62 is configured as a compression spring, and the returning member 62 is disposed between a wall surface of the base 441 and the second linking portion 613b of the linking body 613. When the two ends of the returning member 62 respectively contact and abut against the wall surface of the base 441 and the second linking portion 613b of the linking body 613, the returning member 62 will be deformed to generate a positioning action force F acting on the linking body 613 (as shown in FIG. 7A).

Referring to FIGS. 7A, 7B, 7C and 7D, are specific applications in the positioning mechanism 60 controls whether the movable bracket arm 51c of the bracket arm group 50 is moved. Firstly, as shown in FIG. 7A, the returning member 62 of the positioning mechanism 60 is simultaneously pushed the actuating body 611, the brake pad 612 and the linking body 613 of the movable member 61 through the positioning action force F, so that the brake pad 612 gradually approaches the built-in section 511a of the movable bracket arm 51c, and meanwhile the linking body 613 moves towards the first positioning surface 441f of the positioning space 441e, and the actuating body 611 gradually moves far away from the built-in section 511a, so that the actuating body 611 is moved inside the switch through hole 441c of the connecting frame 40. When the brake pad 612 contacts the built-in section 511a of the movable bracket arm 51c, the movable member 61 is located at a contact position P1 to generate a frictional force between the brake pad 612 and the built-in section 511a, so that the movable bracket arm 51c is stopped to move relative to the connecting frame 40, and the size of the clamping area R of the bracket arm group 50 is not adjusted. In a preferred embodiment, when the movable member 61 is located at the contact position P1, the linking body 613 is spaced apart from the first positioning surface 441f of the positioning space 441e. Additionally, as shown in FIG. 7B, the actuating body 611 is pressed to allow the movable member 61 to move along the brake axis L4, and the moving actuating body 611 is gradually approached the built-in section 511a, and the moving actuating body 611 is driven the brake pad 612 to move via the linking body 613, so that the movable member 61 moves from the contact position P1 to a separation position P2, and the brake pad 612 is enabled to be separated from the built-in section 511a of the movable bracket arm 51c. At the same time, the linking body 613 is spaced apart from the second positioning surface 441g of the positioning space 441e, whereby the first positioning surface 441f or the second positioning surface 441g are limited the moving distance of the actuating body 611 in the connecting space 441d. When the movable member 61 is located at the separation position P2, no frictional force is generated between the brake pad 612 and the built-in section 511a. At this time, as shown in FIG. 7C, the movable bracket arm 51c moves relative to the connecting frame 40 along the moving axis L3, so that the first anti-detachment block 511d of the movable bracket arm 51c is far away from the connecting frame 40, and meanwhile the second anti-detachment block 511e of the movable bracket arm 51c will be close to the connecting frame 40, and a length of the first exposed section 511b of the movable bracket arm 51c will be increased, while a length of the second exposed section 511c of the movable bracket arm 51c will be decreased, thereby expanding the contour of the clamping area R. When the second anti-detachment block 511e contacts the base 441 of the connecting frame 40, the movable bracket arm 51c will be stationary relative to the connecting frame 40 to prevent separation from the connecting frame 40, so that the contour of the clamping area R is maximized. Also as shown in FIG. 7D, the movable bracket arm 51c moves relative to the connecting frame 40 along the moving axis L3, so that the first anti-detachment block 511d will be close to the connecting frame 40, and meanwhile, the second anti-detachment block 511e will be far away from the connecting frame 40, and the length of the first exposed section 511b will be decreased and the length of the second exposed section 511c will be decreased, thereby reducing the contour of the clamping area R. When the first anti-detachment block 511d contacts the base 441, the movable bracket arm 51c will be stationary relative to the connecting frame 40 to prevent separation from the connecting frame 40, so that the contour of the clamping area R is minimized.

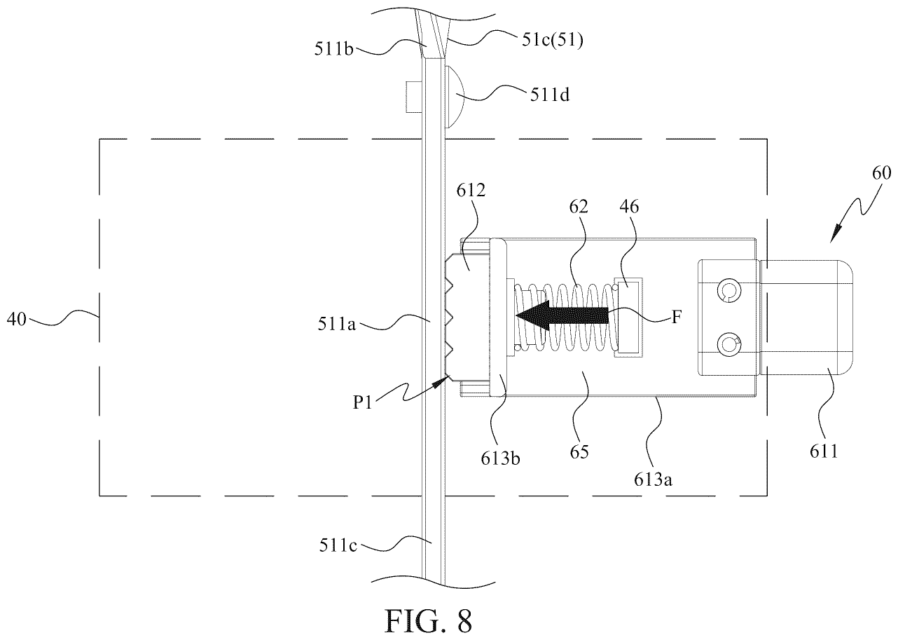

Referring to FIG. 8, in a second preferred embodiment, it differs from the first preferred embodiment in the arrangement relationship between the movable bracket arm 51c of the bracket arm group 50 and the positioning mechanism 60, and the structure patterns of the six ones, namely the support 10, the supporting foot rest 20, the angle adjuster 30, the connecting frame 40, the bracket arm group 50 and the positioning mechanism 60, are the same as those in the first preferred embodiment. Therefore, in this embodiment, the description of the structure patterns of the six ones, namely the support 10, the supporting foot rest 20, the angle adjuster 30, the connecting frame 40, the bracket arm group 50 and the positioning mechanism 60 will not be repeated any more. As shown in the figure, the actuating body 611 of the positioning mechanism 60 and the brake pad 612 of the positioning mechanism 60 are both located on the same side of the built-in section 511a of the movable bracket arm 51c, and the first linking portion 613a of the linking body 613 is inserted by a vertical column 46 formed on the connecting frame 40, so that the vertical column 46 is located inside the accommodating channel 63. The returning member 62 of the positioning mechanism 60 is located inside the accommodating channel 63, and the two ends of the returning member 62 respectively abut against the second linking portion 613b of the linking body 613 and the vertical column 46 of the connecting frame 40. When the two ends of the returning member 62 are respectively in contact with and abut against the second linking portion 613b and the vertical column 46 of the connecting frame 40, the returning member 62 will be deformed to generate a positioning action force F. Thus, the returning member 62 is driven the brake pad 612 to be located at the contact position P1 through the positioning action force F, so that the movable bracket arm 51c is stopped to move relative to the connecting frame 40.

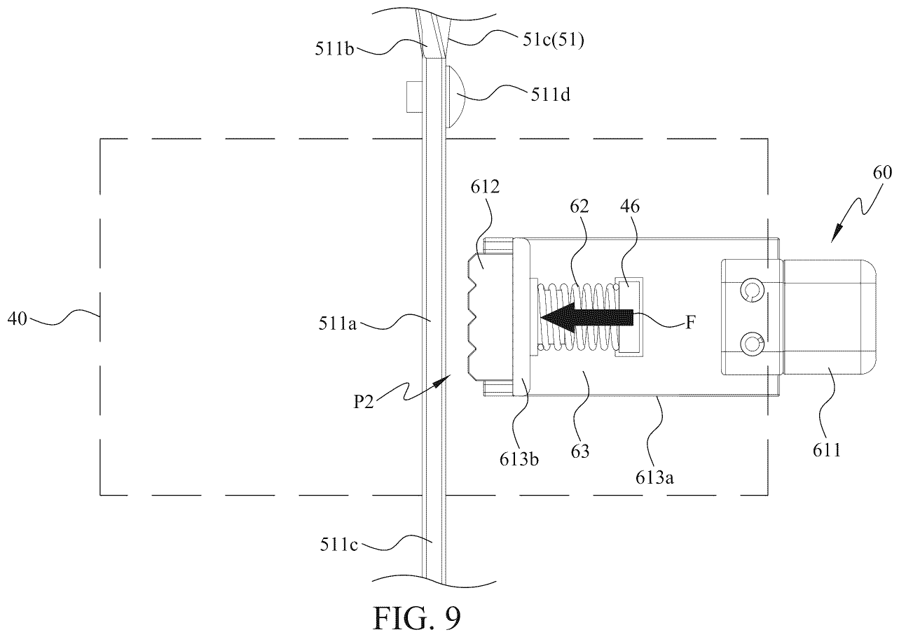

Referring to FIG. 9, is a specific application of adjusting the clamping region R in the second embodiment. The actuating body 611 of the positioning mechanism 60 is pulled to move along the brake axis L4, and the actuating body 611, the brake pad 612 and the linking body 613 of the positioning mechanism 60 are all far away from the built-in section 511a of the movable bracket arm 51c at the same time, so that the movable member 61 moves from the contact position P1 to a separation position P2. Thereby, the movable bracket arm 51c moves relative to the connecting frame 40 along the moving axis L3 to increase or reduce the contour size of the clamping region R.

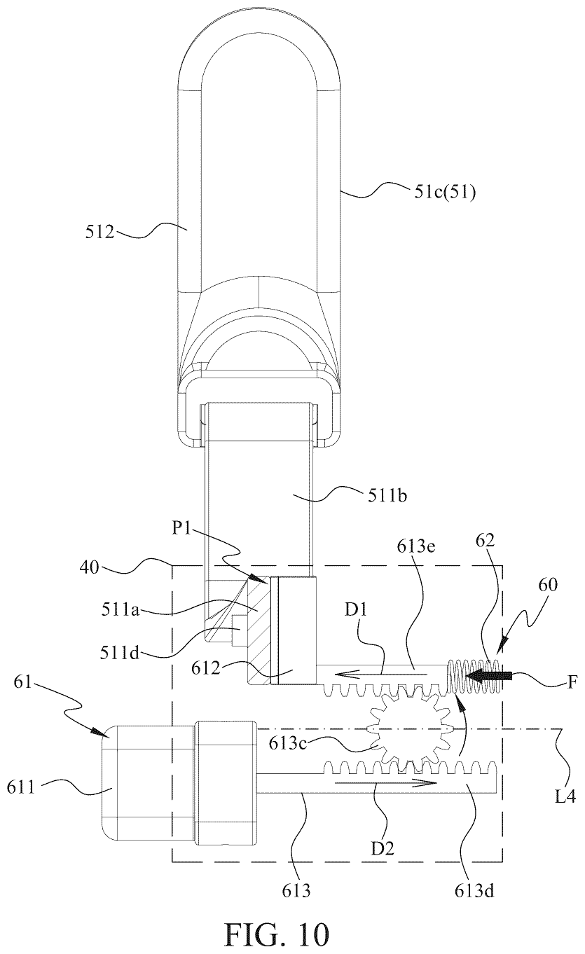

Referring to FIG. 10, in a third preferred embodiment, it differs from the first preferred embodiment in the structural pattern of the linking body 613 of the positioning mechanism 60, and the structural patterns of the five ones, namely the support 10, the supporting foot rest 20, the angle adjuster 30, the connecting frame 40 and the bracket arm group 50, are the same as those of the first preferred embodiment. Therefore, in this embodiment, the description of the support 10, the supporting foot rest 20, the angle adjuster 30, the connecting frame 40 and the bracket arm group 50 will not be repeated any more. As shown in the figure, the linking body 613 is used for allowing the actuating body 611 of the positioning mechanism 60 and the brake plate 612 of the positioning mechanism 60 to move in opposite directions of the brake axis L4, when the actuating body 611 moves along a first direction D1 of the brake axis L4, the brake plate 612 is capable of being moved along a second direction D2 of the brake axis L4 at the same time, where the first direction D1 is opposite to the second direction D2. In this embodiment, the linking body 613 has three portions, namely a linkage gear 613c, an actuating rack 613d and an abutting rack 613e. The linkage gear 613c is pivoted to the base 441 of the connecting frame 40, so that the linkage gear 613c is rotated relative to the base 441, and the actuating rack 613d is connected to the actuating body 611, and the actuating rack 613d is meshed with one side of the linkage gear 613c. Additionally, the abutting rack 613e is connected to the brake pad 612, and the abutting rack 613e is meshed with the other opposite side of the linkage gear 613c, so that the abutting rack 613e is arranged in parallel with the actuating rack 613d, and the returning member 62 of the positioning mechanism 60 is arranged between the connecting frame 40 and the abutting rack 613e. When the returning member 62 is arranged between the connecting frame 40 and the abutting rack 613e, the returning member 62 will be deformed to generate a positioning action force F to act on the abutting rack 613e. Thereby, the abutting rack 613e to move along the first direction D1 of the brake axis L4 through the positioning action force F, so that the movable member 61 is moved to the contact position P1 to prevent the movable bracket arm 51c from moving relative to the connecting frame 40. At the same time, the movement of the abutting rack 613e toward the first direction D1 is driven the linkage gear 613c to rotate counterclockwise, so that the actuating rack 613d is driven the actuating body 611 to move along the second direction D2.

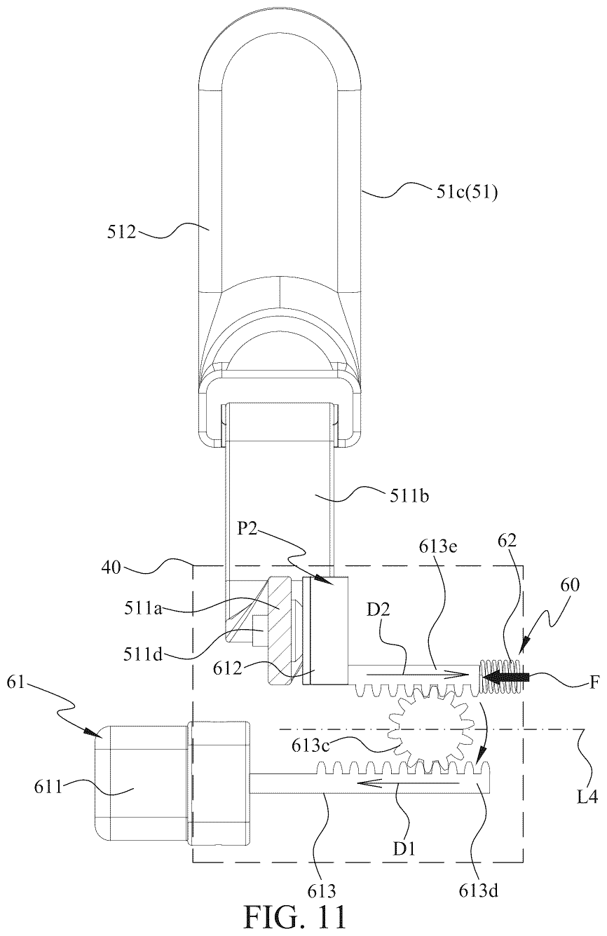

Referring to FIG. 11, is a specific application of adjusting the clamping area R in the third embodiment. The actuating body 611 of the positioning mechanism 60 is pulled to move along the first direction D1 of the brake axis L4, and the movement of the actuating rack 613d towards the first direction D1 is driven the linkage gear 613c of the linking body 613 to rotate clockwise. At the same time, the clockwise rotation of linkage gear 613c is driven the abutting rack 613e of the linking body 613 to move along the second direction D2 of the brake axis L4, so that the movable member 61 is moved from the contact position P1 to the separation position P2 along the second direction D2. Thereby, the movable bracket arm 51c moves relative to the connecting frame 40 along the moving axis L3 to increase or reduce the contour size of the clamping area R.

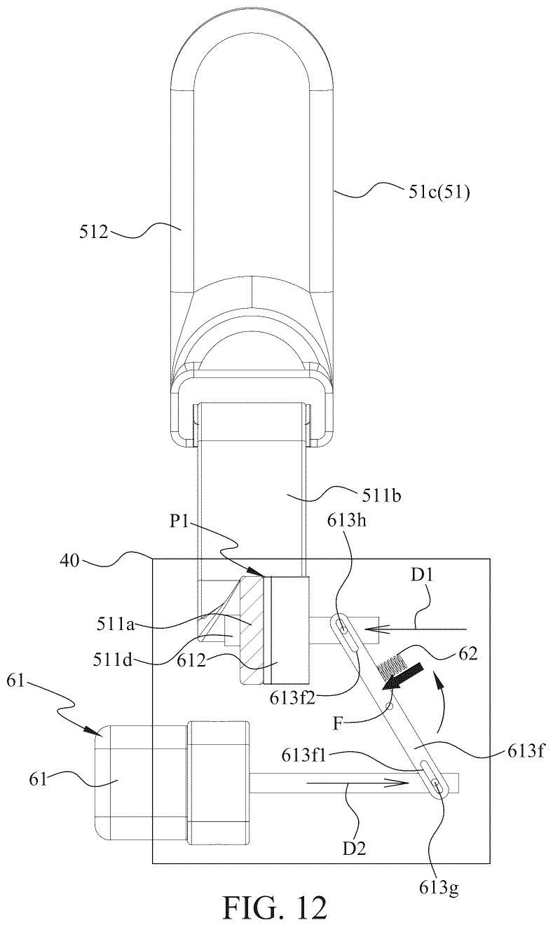

Referring to FIG. 12, in a fourth preferred embodiment, it differs from the third preferred embodiment in the structural pattern of the linking body 613 of the positioning mechanism 60. As shown in the figure, the linking body 613 has three portions, namely a linkage rod 613f, an actuating protrusion 613g and an abutting protrusion 613h. The linkage rod 613f is pivoted to the base 441 of the connecting frame 40 so that the linkage rod 613f is rotated relative to the connecting frame 40. Additionally, the linkage rod 613f is formed with an actuating slot hole 613f1 and an abutting slot hole 613f2 at two ends thereof respectively, the actuating protrusion 613g is formed on the actuating body 611 to insert into the interior of the actuating slot hole 613f1, and the abutting protrusion 613h is formed on the brake pad 612 to insert into the interior of the abutting slot hole 613f2. The returning member 62 of the positioning mechanism 60 is arranged between the connecting frame 40 and the linkage rod 613f, where when the returning member 62 is arranged between the connecting frame 40 and the linkage rod 613f, the returning member 62 will be deformed to generate a positioning action force F to act on the linkage rod 613f, so that the linkage rod 613f is rotated counterclockwise through the positioning action force F, and the actuating protrusion 613g will move inside the actuating slot hole 613f1, and the abutting protrusion 613h will move inside the abutting slot hole 613f2 at the same time, so that the relative position between the actuating protrusion 613g and the actuating slot hole 613f1 and the relative position between the abutting protrusion 613h and the abutting slot hole 613f2 will be changed. Therefore, the brake plate 612 is moved towards the first direction D1 through the linkage rod 613f rotating counterclockwise, so that the movable member 61 is located at the contact position P1, and at the same time the actuating body 611 is moved towards the second direction D2 through the linkage rod 613f rotating counterclockwise.

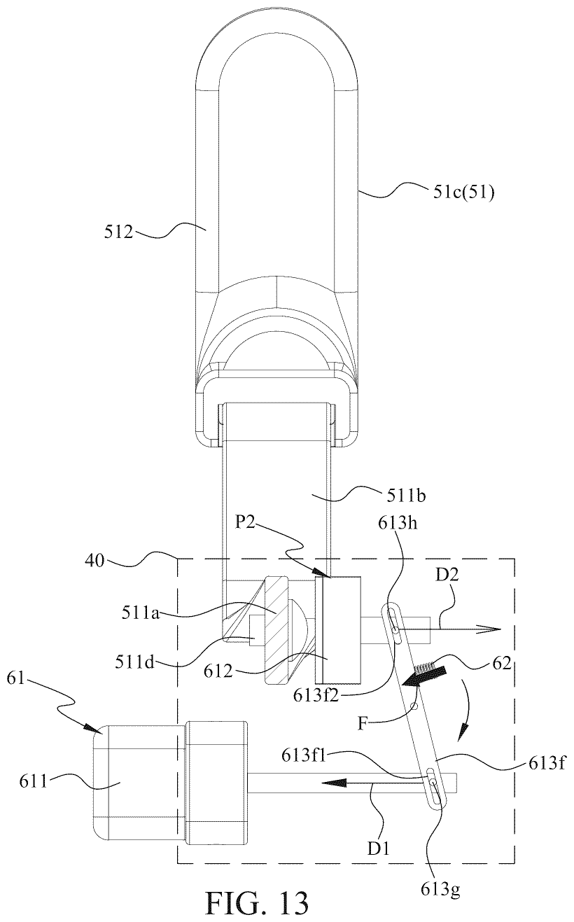

Referring to FIG. 13, is a specific application of adjusting the clamping area R in the fourth embodiment. The actuating body 611 of the positioning mechanism 60 is pulled to move along the first direction D1 of the brake axis L4, so that the actuating protrusion 613g of the linking body 613 moves synchronously along the first direction D1 to allow the actuating protrusion 613g to move inside the actuating slot hole 613f1 of the linkage rod 613f, and the linkage rod 613f is rotated clockwise through the actuating body 611 moving along the first direction D1, when the relative position between the abutting protrusion 613h of the linking body 613 and the abutting slot hole 613f2 of the linkage rod 613f, and causing that the movable member 61 is moved from the contact position P1 to the separation position P2 along the second direction D2. Thereby, the movable bracket arm 51c moves relative to the connecting frame 40 along the moving axis L3 to increase or reduce the contour size of the clamping area R.

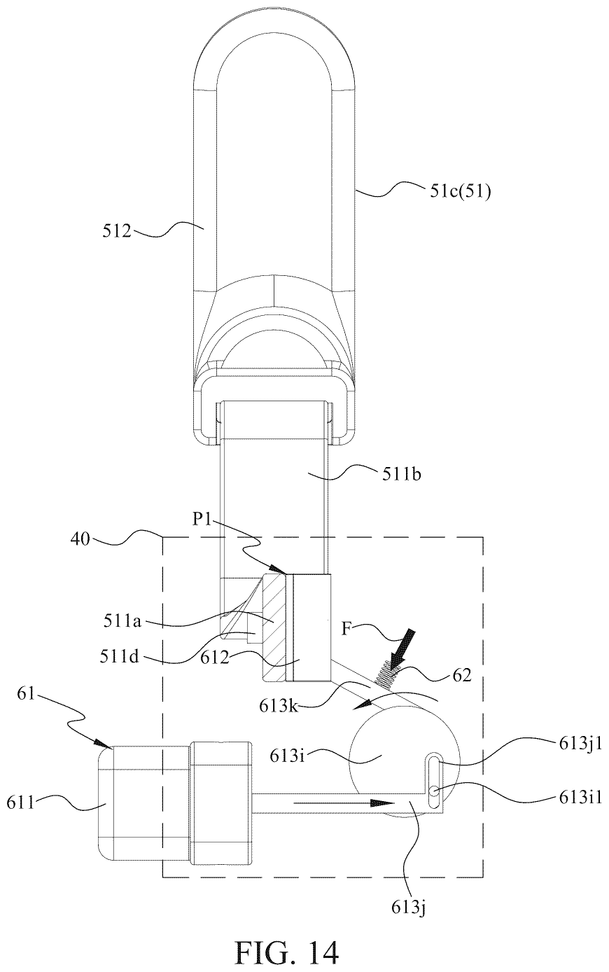

Referring to FIG. 14, in a fifth preferred embodiment, it differs from the first preferred embodiment in the structural pattern of the linking body 613 of the positioning mechanism 60. In this embodiment, the linking body 613 is used for converting the linear motion into the rotational motion. The linking body 613 is connected between the actuating body 611 of the positioning mechanism 60 and the brake plate 612 of the positioning mechanism 60, when the actuating body 611 moves along the brake axis L4, the linking body 613 is driven the brake plate 612 to swing to approach or move far away from the movable bracket arm 51c. As shown in the figure, the linking body 613 has three portions, namely a rotating disk 613i, a moving rod 613j and a swinging rod 613k. The rotating disk 613i is pivoted to the connecting frame 40, and a surface of the rotating disk 613i protrudes to form a disk protrusion 613i1. The moving rod 613j is connected to the actuating body 611. Moreover, the movable rod 613j is provided with a longitudinal slot 613j1 at one end close to the rotating disk 613i, is inserted by the disk protrusion 613i1, the swing rod 613k is connected between the brake pad 612 and the rotating disk 613i. Additionally, the returning member 62 of the positioning mechanism 60 is arranged between the connecting frame 40 and the swing rod 613k. When the returning member 62 is arranged between the connecting frame 40 and the swing rod 613k, the returning member 62 will be deformed to generate a positioning action force F to act on the swing rod 613k. Thereby, the returning member 62 is driven the swing rod 613k to swing through the positioning action force F, so that the brake pad 612 contacts the movable bracket arm 51c, and the movable member 61 is enabled to move to the contact position P1 to prevent the movable bracket arm 51c from moving relative to the connecting frame 40. At the same time, the rotating disk 613i rotates counterclockwise to allow the disk protrusion 613i1 to move inside the longitudinal slot 613j1, when the relative position between the disk protrusion 613i1 and the longitudinal slot 613j1, and causing the moving rod 613j to drive the actuating body 611 to move.

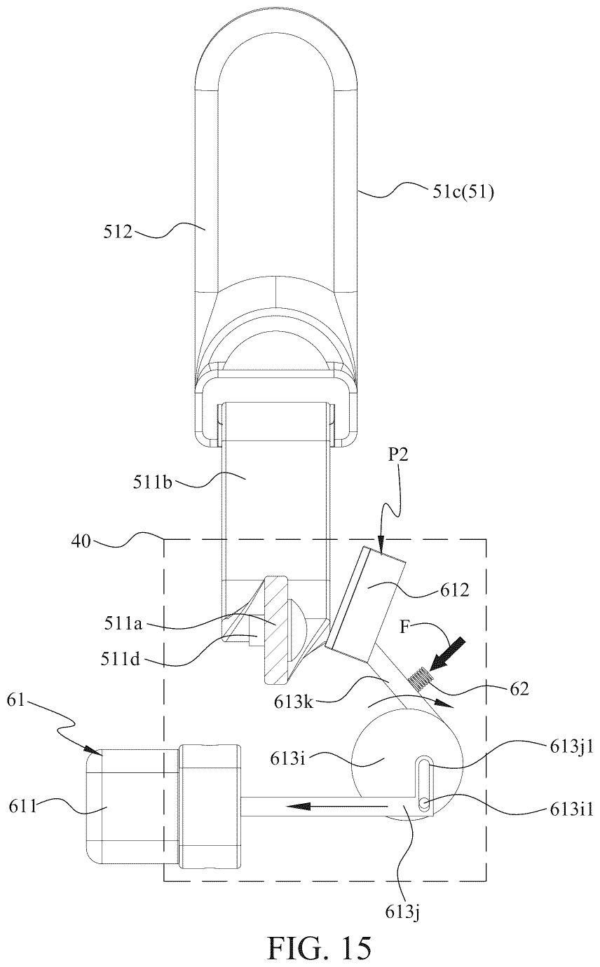

Referring to FIG. 15, is a specific application of adjusting the clamping area R in the fifth embodiment. The actuating body 611 of the positioning mechanism 60 is pulled to drive the moving rod 613j of the linking body 613 to move along the brake axis L4, and the movement of the moving rod 613j towards the first direction D1 is driven the rotating disk 613i of the linking body 613 to rotate clockwise. At the same time, the disk protrusion 613i1 of the rotating disk 613i moves inside the longitudinal slot 613j1 of the moving rod 613j, and the swing rod 613k of the linking body 613 drives the brake plate 612 of the movable member 61 to separate from the movable bracket arm 51c, so that the movable member 61 is located at the separation position P2. Thereby, the movable bracket arm 51c moves relative to the connecting frame 40 along the moving axis L3 to increase or reduce the contour size of the clamping area R.

The above embodiments are only for the convenience of explaining the invention and are not intended to limit the invention. Without departing from the invention scope of the invention, various simple deformations and modifications made by those skilled in the art according to the claims and invention description of the invention should still be included in the following claims.

What is claimed is:

1. A musical instrument stand for holding a musical instrument, comprising:
a connecting frame;
a bracket arm group having a plurality of bracket arms connected to the connecting frame, wherein a clamping area is formed between the bracket arms for clamping the musical instrument, and one of the bracket arms is configured as a movable bracket arm movably connected to the connecting frame, and the movable bracket arm is capable of being moved along a moving axis to expand or shrink the clamping area; and
a positioning mechanism is disposed on the connecting frame and has a movable member and a returning member, the movable member is movably connected to the connecting frame, so that the movable member is capable of being moved along a brake axis intersecting the moving axis, and the movable member is moved back and forth between a separation position separated from the movable bracket arm and a contact position in contact with the movable bracket arm, and the movable member is moved by the returning member to kept in the contact position, so that the movable bracket arm is stopped to move relative to the connecting frame.

2. The musical instrument stand according to claim 1, wherein the movable member has an actuating body and a brake pad, when the movable member is moved to the separation position by operating the actuating body, the brake pad is separated from the movable bracket arm, and when the movable member is located at the contact position, the brake pad is contact with the movable bracket arm.

3. The musical instrument stand according to claim 2, wherein the movable member further has a linking body connected between the actuating body and the brake pad, so that the actuating body and the brake pad are moved by the linking body in the same direction of the brake axis, and an accommodating channel is formed among the actuating body, the brake pad and the linking body.

4. The musical instrument stand according to claim 3, wherein the actuating body is located on one side of the movable bracket arm, and the brake pad is located on the other side of the movable bracket arm, so that the movable bracket arm is capable of passing through the accommodating channel, and a part of the movable bracket arm is allowed to be located inside the accommodating channel, while two ends of the returning member respectively abut against the linking body and the connecting frame.

5. The musical instrument stand according to claim 3, wherein the actuating body and the brake pad are both located on the same side of the movable bracket arm, and the returning member is located inside the accommodating channel and respectively abuts against the linking body and the connecting frame at both ends.

6. The musical instrument stand according to claim 2, wherein the movable member further has a linking body for allowing the actuating body and the brake pad to move in opposite directions of the brake axis, so that the actuating body moves along a first direction of the brake axis, while the brake pad moves along a second direction of the brake axis, and the first direction is opposite to the second direction.

7. The musical instrument stand according to claim 6, wherein the linking body has a linkage gear pivoted to the connecting frame, an actuating rack connected to the actuating body and an abutting rack connected to the brake pad, the actuating rack and the abutting rack are respectively meshed with opposite sides of the linkage gear, so that when the actuating body moves along the first direction of the brake axis, the actuating rack is drove the linkage gear to rotate, and the abutting rack ismoved along the second direction of the brake axis through the rotating linkage gear.

8. The musical instrument stand according to claim 6, wherein the linking body comprises:
a linkage rod that is pivoted to the connection frame and has an actuating slot hole and an abutting slot hole formed at two ends;
an actuating projection that is formed on the actuating body for inserting into the interior of the actuating slot hole; and
an abutting protrusion that is formed on the brake pad for inserting into the interior of the abutting slot hole;
wherein the actuating protrusion is moved by the actuating body along the first direction of the brake axis, so that the actuating protrusion moves inside the actuating slot hole to allow the linkage rod to swing, when the relative position between the abutting protrusion and the abutting slot hole is changed, and the brake pad is moved by the abutting protrusion along the second direction of the brake axis.

9. The musical instrument stand according to claim 2, wherein the positioning mechanism further has a linking body for converting linear motion into rotational motion, the linking body is connected between the actuating body and the brake pad, when the actuating body moves along the brake axis, the brake pad is swung by the linking body to get closer to or for away from the movable bracket arm.

10. The musical instrument stand according to claim 9, wherein the linking body comprises:
a moving rod that is connected to the actuating body and has a longitudinal slot;
a rotating disk that is pivoted to the connecting frame and has a disk protrusion for inserting into the longitudinal slot; and
a swinging rod connected between the brake pad and the rotating disk;
wherein a relative position between the disk protrusion and the longitudinal slot is changed according to the actuating body move along the brake axis, when the rotating disk rotates, the brake pad is swung by the swinging rod to get closer to or far away from the movable bracket arm.

11. The musical instrument stand according to claim 2, wherein a connecting space is provided inside the connecting frame to accommodate the actuating body and the brake pad, and the connecting frame has bracket through-holes communicated with the connecting space, the movable bracket arm is disposed in the bracket through-holes, so that the movable bracket arm is formed with a built-in section located in the connecting space and two exposed sections protruding from the bracket through-holes, the built-in section is located between the exposed sections, and each of the exposed sections are protruded outside the connecting space to form an anti-detachment block; when the movable bracket arm is moved along the moving axis, the anti-detachment block of the exposed sections is contact with the connecting frame for preventing the movable bracket arm from separating the connecting frame.

12. The musical instrument stand according to claim 11, wherein the connecting frame is provided with positioning surfaces spaced each other in the connecting space, and a linking body connected between the actuating body and the brake pad is located between the positioning surfaces, and when the actuating body moves along the brake axis, the linking body is contact with one of the positioning surfaces to limit a moving distance of the actuating body in the connecting space.

13. The musical instrument stand according to claim 12, wherein a positioning space is further provided in the connecting frame and locates below the connecting space, and the positioning surfaces are formed on two opposite sides of the positioning space, so that a part of the linking body is arranged inside the positioning space.

14. The musical instrument stand according to claim 1, wherein the connecting frame is provided with a first connecting portion connected to the bracket arm group and a second connecting portion formed on one side of the first connecting portion, and a transverse cross-sectional profile of the first connecting portion is larger than that of the second connecting portion, so that an exposed space is formed between the first connecting portion and the second connecting portion of the connecting frame, and the second connecting portion is connected to a support via an angle adjuster, and the angle adjuster is located inside the exposed space for changing an assembling angle of the connecting frame.

15. The musical instrument stand according to claim 14, wherein the connecting frame has a connecting body and a covering body, the connecting body is provided with a base, a connecting arm formed on the base and a pivot rod connected to the connecting arm, the covering body is connected to the base, so that the covering body and the base together form the first connecting portion, and the pivot rod is pivoted to the angle adjuster, so that the connecting arm is adjacent to the angle adjuster, and the connecting arm and the pivot rod together form the second connecting portion.
